(19) United States
(12) Patent Application Publication
(10) Pub. No.: US 2016/0124914 A1
(43) Pub. Date: May 5, 2016

(54) Page Processing for Mobile App

(71) Applicant: Alibaba Group Holding Limited, Grand Cayman (KY)

(72) Inventor: Yulin Deng, Hangzhou (CN)

(21) Appl. No.: 14/927,351

(22) Filed: Oct. 29, 2015

(30) Foreign Application Priority Data
Oct. 30, 2014 (CN) 201410596965.1

(51) Int. Cl. G06F 17/21; G06F 3/0484; G06F 17/22

(52) U.S. Cl. CPC G06F 17/212; G06F 17/2247; G06F 3/04847

(57) ABSTRACT

Methods, devices, and systems for processing mobile application pages and updating mobile application pages on a client terminal. A method for processing mobile application pages includes parsing, by a computing device, the mobile application page returned from a server terminal to convert the mobile application page to an object recognizable by a client terminal. The computing device may traverse the page components of the object and generate instances of the page components. The computing device may further configure the instances of the pate components, render the instances of the page components, and return the rendered instance to the object to generate a local object corresponding to the mobile application page on the client terminal. The implementations enable mobile application pages to be developed in low cost and to have good user experience similar to those of native applications.

### CROSS REFERENCE TO RELATED PATENT APPLICATIONS

This application claims priority to Chinese Patent Application No. 201410596965.1, filed on Oct. 30, 2014, entitled “Methods, Devices, and Systems for Processing Mobile Application Pages,” which is hereby incorporated by reference in its entirety.

### TECHNICAL FIELD

The present disclosure relates to mobile Internet technology and, more specifically, to methods, devices, and systems for processing mobile application pages and updating mobile application pages on a client terminal.

### BACKGROUND

With the continuous development of mobile Internet technology, companies need to choose a mobile development mode for needs in various levels. Currently, mobile development models include native development model, web development model and a mixed development mode. Displaying mobile application pages depends on a development mode of a corresponding mobile application (e.g., mobile App) and a type of mobile application.

Types of mobile applications include native applications, web applications, and hybrid applications. A native App is an application developed using a platform-specific application development language. With respect to native Apps, the client terminal has different modules and a decision for presenting certain content is made by requesting data from a server terminal. Web Apps adopt a unified standard HyperText Markup Language (HTML), JAVASCRIPT®, Cascading Style Sheets (CSS) and other Web technologies for development. Through a browser to access the different platforms, web Apps can achieve cross-platform visiting. Hybrid Apps are used to compensate for defects of native Apps and web Apps. In mixing applications, hybrid Apps use HTML5 instead of the dynamic region.

While using web development languages and programming languages, hybrid Apps are packaged and distributed through various App stores. Features of hybrid Apps are closer to native Apps and different from web Apps. Advantages and disadvantages of native Apps, web Apps, and hybrid Apps are listed in table 1.

TABLE 1
Advantages and disadvantages of different modes of mobile applications

| | Native App | Web App | Mixed App |
|---|---|---|---|
| Development costs | High | Low | Medium |
| Maintenance Update | Complex | Simple | Simple |
| user experience | Excellent | Poor | Medium |
| Store or market recognition | Approve | Disapprove | Approve |
| Installation | Required | Not required | Required |
| Cross-platform | Poor | Excellent | Excellent |

As Table 1 shown, native Apps require great developmental costs, and each client platform requires independent development and maintenance as well as a corresponding component library. Their components may be different and include multiple fixed several styles. Updating of native Apps is difficult since users have to download new application packages. Thus, these hard-coded components on the client terminal lack scalability. Meanwhile, with an increase in application package components, the equipment, users and developers may add additional costs. Although having optimal user experience, native Apps have the highest development and maintenance costs.

Web Apps adopt a unified standard HTML, JAVASCRIPT, CSS and other Web technologies for development. Therefore, developmental costs of web Apps are minimal. On the other hand, web Apps have the worst user experience because processing and displaying pages with respect to web Apps depend on browsers on the client terminal. Pages of hybrid Apps depends on WebView techniques, and thus operability of hybrid Apps are worse than that of native Apps, such as gestures and animation pause etc. Hybrid Apps have better user experience than web Apps but worse than native Apps. Also, development of hybrid Apps requires that developers understand various clients terminals (e.g., iOS, Android, etc.) and web developers know hybrid applications. Thus, hybrid Apps have lower development and maintenance costs than native Apps but higher than web Apps.

In sum, under current techniques, there is room for improvement of compatibility and user experience while keeping development and maintenance costs relative low.

### SUMMARY

Implementations herein relate to methods and devices for processing mobile application pages. The implementations may reduce development costs and improve user experience. The implementations further relate to methods and devices for updating mobile application pages on a client terminal and systems for processing the mobile application pages. This Summary is not intended to identify all key features or essential features of the claimed subject matter, nor is it intended to be used alone as an aid in determining the scope of the claimed subject matter.

The implementations include a method for processing mobile application pages. The method may include receiving, by a computing device, an access request for a mobile application page. The computing device may request to a server terminal the mobile application page based on a uniform resource locator (URL) of the access request and receive the mobile application page from the server. The mobile application page may include a page layout and page components. The computing device may further parse the mobile application page to convert the mobile application page to an object recognizable by a client terminal, and then traverse the page components of the object to generate an instance of each of the page components based on a type of the one of the page components and a base component library of the client terminal.

The computing device may further configure the instance of each of the page components based on one or more attributes of the one of the page components and render the instance of the one of the page components. The computing device may return the rendered instance to the object, generate a local object corresponding to the mobile application page on the client terminal, and display the mobile application page based on the local object.

In implementations, prior to generating an instance of each of the page components based on a type of the one of the page components and a base component library of the client terminal, the computing device may acquire a component registry that is pre-stored on the client terminal, and initialize the base component library of the client terminal based on the component registry. In these instances, the component registry may indicate a corresponding relationship between a type of a base component and a category of the base component, and the base component may include a button component, an image component, a labeling component, and a text component. For instance, the mobile application page may include a page expressed using a Json data exchange format or a XML markup extension language.

In implementations, the computing device may parse the mobile application page to convert the mobile application page to an object recognizable by a client terminal by parsing the page expressed using the Json data exchange format to convert the page to the object recognizable by the client terminal.

In implementations, the computing device may parse the mobile application page to convert the mobile application page to an object recognizable by a client terminal by parsing the page expressed using the XML markup extension language to convert the page to the page recognizable by the client terminal.

In implementations, prior to generating an instance of each of the page components based on a type of the one of the page components and a base component library of the client terminal, the computing device may acquire categories of the page components from the base component library of the client terminal based on the types of the page components and generate the instance of page components based on the categories of the page components.

In implementations, the one or more attributes of the page components may include a style attribute, a component attribute, a logical attribute, an edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

In implementations, the configuring the instance of the one of the page components based on one or more attributes of the one of the page components may include parsing the mobile application page to acquire the style attribute, the component attribute, the logical attribute, the edit attribute, and/or the binding attribute and configuring the instance of the one of the page components based on the style attribute, the component attribute, the logical attribute, the edit attribute, and/or the binding attribute. In implementations, a binding method of dynamic data of the binding attribute may include dynamical binding, static binding, and dependent binding.

The implementations include a device corresponding to the method expressed above. The device may include a receiving request module configured to receive an access request for a mobile application page, a transmitting request module configured to request to a server the mobile application page based on an uniform resource locator (URL) of the access request, and a receiving page module configured to receive the mobile application page from the server. The mobile application page may include a page layout and page components.

The device may further include a parsing module configured to parse the mobile application page to convert the mobile application page to an object recognizable by a client terminal, a traversing module configured to traverse the page components of the object, to generate an instance of each of the page components based on a type of the one of the page components and a base component library of the client terminal, and to configure the instance of the one of the page components based on one or more attributes of the one of the page components.

The device may further include a generating module configured to return the rendered instance to the object and generating a local object corresponding to the mobile application page on the client terminal, and a displaying module configured to display the mobile application page based on the local object.

In implementations, the device may include an acquiring registry module configured to acquire a component registry that is pre-stored on the client terminal, an initialization component library module configured to initialize the base component library of the client terminal based on the component registry. In these instances, the component registry may indicate a corresponding relationship between a type of a base component and a category of the base component, the base component may include a button component, an image component, a labeling component, and a text component. For instance, the mobile application page including a page expressed using a Json data exchange format or a XML markup extension language.

For instance, the parsing the mobile application page to convert the mobile application page to an object recognizable by a client terminal may include parsing the page expressed using the Json data exchange format to convert the page to the object recognizable by the client terminal. For instance, the parsing the mobile application page to convert the mobile application page to an object recognizable by a client terminal may include parsing the page expressed in the XML markup extension language to convert the page to the page recognizable by the client terminal.

In implementations, the traversing module may include a generating component instance module configured to generate an instance of each of the page components based a type of the one of the page components and a base component library of the client terminal. The generating component instance module may include an acquiring component class submodule configured to acquire categories of the page components from the base component library of the client terminal based on the types of the page components, and a generating component instance submodule configured to generate the instances of page components based on the categories of the page components.

For instance, the one or more attributes of the page components may include a style attribute, a component attribute, a logical attribute, an edit attribute, and/or a binding attribute. The component attribute may include a character description of a component. The style attribute may include a style description of the component including a width, a height, and/or color.

The logical attribute may include control statements supported by the component including conditional statements and/or loop execute statements. The edit attribute may include an editing rule of the component. The binding attribute may include an event, animation, dynamic data, style, and/or bury point data that are bound to the component.

In implementations, the traversing module may include a configuration component module configured to configure the instances of the page components based on one or more attributes of the page components. In these instances, the configuration component module may include an acquiring property submodule configured to parse the mobile application page to acquire the style attribute, the component attribute, the logical attribute, the edit attribute, and/or the binding attribute, and a configuration component submodule configured to configure the instances of the page components based on the style attribute, the component attribute, the logical attribute, the edit attribute, and/or the binding attribute. For instance, a binding method of dynamic data of the binding attribute may include dynamical binding, static binding, and dependent binding.

The implementations include a method for updating mobile application pages on a client terminal. The method may include receiving, by a computing device, a URL of a mobile application page from a client terminal, acquiring a page identifier of the mobile application page based on the URL, and acquiring a custom page fragment of the mobile application page, a template, and/or all page components of the mobile application page based on the page identifier.

The computing device may generate the mobile application page based on custom page fragment of the mobile application page, a template, and/or all page components of the mobile application page. In these instances, dynamic data and a style of a binding attribute of a page component are included in the mobile application page. The computing device may further receive the mobile application page from the server, and the mobile application page including a page layout and page components.

For instance, the URL may include a name of the mobile application page, a namespace of the mobile application page, and/or a user account of the mobile application page.

For instance, the acquiring a page identifier of the mobile application page based on the URL may include acquiring the name of the mobile application page, the namespace of the mobile application page, and/or the user account of the mobile application page based on the URL, and acquiring a page identifier of the mobile application page based on the name of the mobile application page, the namespace of the mobile application page, and/or the user account of the mobile application page.

For instance, the acquiring a page identifier of the mobile application page based on the URL may include determining whether to use an evaluation template or an evaluation page to the mobile application page based on the page identifier of the mobile application page and a configuration file of a A/B test that is preset on a server terminal, and in response to using the evaluation template or the evaluation page, and designating a template identifier of the evaluation template or a page identifier of the evaluation page as the page identifier of the mobile application page.

For instance, the custom page fragment of the mobile application page, the template, and/or all page components of the mobile application page are expressed using a Json data exchange format or a XML markup extension language. For instance, the mobile application page including a page expressed using a Json data exchange format or a XML markup extension language.

For instance, the one or more attributes of the page components may include a style attribute, a component attribute, a logical attribute, a edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

For instance, the custom page fragment of the mobile application page, the template, and/or the all page components of the mobile application page are stored in a database.

For instance, prior to returning the mobile application page to the client terminal, the computing device may convert the mobile application page to a page expressed using a Json data exchange format or a XML markup extension language.

For instance, prior to returning the mobile application page to the client terminal, the computing device may determine whether the mobile application page includes a base component in a high version that is not supported by the base component library of the client terminal based on a version of the base component library of the client terminal. In response to a determination that the mobile application page includes the base component in the high version, the computing device may represent the base component in the high version using HTML5.

For instance, the representing the base component in the high version using HTML5 may include converting the base component in the high version to a HTML representation using WebView.

For instance, prior to returning the mobile application page to the client terminal, the method may include acquiring a client machine model of the client terminal and a version of the base component library of the client terminal, and determine whether a server terminal includes a configuration logic compatible to the version of the base component library of the client terminal based on client machine model of the client terminal and a version of base component library of the client terminal.

In response to a determination that the server terminal includes the configuration logic compatible to the version of the base component library of the client terminal, the computing device may perform a compatibility process on the base component in the high version of the mobile application page based on the configuration logic to convert the base component to a base component recognizable by the client terminal.

In implementations, the mobile application page may be configured to receive by the client terminal a page configuration instruction including at least content of the mobile application page, a name of the mobile application page, a namespace of the mobile application page, and/or a user account of the mobile application page. The content of the mobile application page may include a custom page fragment of the mobile application page, a template, and/or all page components of the mobile application page. The mobile application page may be further configured to transmit the page configuration instruction to the server terminal to request storing the mobile application page by the server terminal.

For instance, prior to receiving the page configuration instruction by the client terminal, the method may include acquiring a page component library and a template library that are preset by the server terminal, and displaying all the page components of the page component library and all the templates of the template library.

For instance, the storing the mobile application page by the server terminal may include receiving the page configuration instruction from the client terminal, acquiring content of the mobile application page, a name of the mobile application page, a namespace of the mobile application page, and/or a user account of the mobile application page based on the page configuration instruction, generating a page identifier of the mobile application page based on the name of the mobile application page, the namespace of the mobile application page, and/or the user account of the mobile application page, and storing the page identifier and the content of the mobile application page. For instances, the page identifier and the content of the mobile application page are stored in a database.

The implementations relate to a device corresponding to the method for updating mobile application pages on a client terminal. The device may include a receiving request module configured to receive a URL of a mobile application page from a client terminal, a first acquiring module configured to acquire a page identifier of the mobile application page based on the URL, and a second acquiring module configured to acquire a custom page fragment of the mobile application page, a template, and/or all page components of the mobile application page based on the page identifier.

The device may further include a generating module configured to generate the mobile application page based on custom page fragment of the mobile application page, a template, and/or all page components of the mobile application page, a configuration module configured to include dynamic data and a style of a binding attribute of a page component in the mobile application page, and a transmitting page module configured to receive the mobile application page from the server; the mobile application page including a page layout and page component.

For instance, the URL may include a name of the mobile application page, a namespace of the mobile application page, and/or a user account of the mobile application page.

In implementations, the first acquiring module may include an acquiring business semantics submodule configured to acquire the name of the mobile application page, the namespace of the mobile application page, and/or the user account of the mobile application page based on the URL, and the acquiring submodule configured to acquire a page identifier of the mobile application page based on the name of the mobile application page, the namespace of the mobile application page, and/or the user account of the mobile application page.

In implementations, the device may further include an A/B testing module configured to determine whether to use an evaluation template or an evaluation page to the mobile application page based on the page identifier of the mobile application page and a configuration file of a A/B test that is preset on a server terminal, and in response to using the evaluation template or the evaluation page, the device may designate a template identifier of the evaluation template or a page identifier of the evaluation page as the page identifier of the mobile application page.

For instance, the custom page fragment of the mobile application page, the template, and/or all page components of the mobile application page are expressed using a Json data exchange format or a XML markup extension language. For instances, the mobile application page including a page expressed using a Json data exchange format or a XML markup extension language.

For instance, the one or more attributes of the page components may include a style attribute, a component attribute, a logical attribute, a edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

For instance, the custom page fragment of the mobile application page, the template, and/or the all page components of the mobile application page are stored in a database.

In implementations, the device may further include a format converting module configured to convert the mobile application page to a page expressed using a Json data exchange format or a XML markup extension language, and a downgrade module configured to determine whether the mobile application page includes a base component in a high version that is not supported by the base component library of the client terminal based on a version of the base component library of the client terminal;

In response to a determination that the mobile application page includes the base component in the high version, the downgrade module may represent the base component in the high version using HTML5.

For instance, the representing the base component in the high version using HTML5 may include converting the base component in the high version to a HTML representation using WebView.

In implementations, the device may further include a third acquisition module configured to acquire a client machine model of the client terminal and a version of the base component library of the client terminal, and a patching module configured to determine whether a server terminal includes a configuration logic compatible to the version of the base component library of the client terminal based on client machine model of the client terminal and a version of base component library of the client terminal.

In response to a determination that the server terminal includes the configuration logic compatible to the version of the base component library of the client terminal, the patching module may perform a compatibility process on the base component in the high version of the mobile application page based on the configuration logic to convert the base component to a base component recognizable by the client terminal.

For instance, the device may include a configuration page module configured to configure the mobile application page. In these instances, the configuration page module may include a receiving instruction module configured to receive by the client terminal a page configuration instruction including at least content of the mobile application page, a name of the mobile application page, a namespace of the mobile application page, and/or a user account of the mobile application page.

For instance, the content of the mobile application page may include a custom page fragment of the mobile application page, a template, and/or all page components of the mobile application page.

In implementations, the device may further include a request storage module configured to transmit the page configuration instruction to the server terminal to request storing the mobile application page by the server terminal, an acquiring library module configured to acquire a page component library and a template library that are preset by the server terminal, and an acquiring component template module configured to display all the page components of the page component library and all the template of the template library.

In implementations, the device may further include a storing page module configured to store the mobile application page on the server terminal. In these instances, the storing page module may include a receiving submodule configured to receive the page configuration instruction from the client terminal, an acquisition sub module configured to acquiring content of the mobile application page, a name of the mobile application page, a namespace of the mobile application page, and/or a user account of the mobile application page based on the page configuration instruction, and a generating submodule configured to generate a page identifier of the mobile application page based on the name of the mobile application page, the namespace of the mobile application page, and/or the user account of the mobile application page.

The storing module may further include a storing submodule configured to store the page identifier and the content of the mobile application page. For instances, the page identifier and the content of the mobile application page are stored in a database.

The implementations include a system for processing mobile application pages. The system may include a device as described above for processing mobile application pages and/or a device as described for updating mobile application pages on a client terminal. Compared with the prior art, one aspect of the present application has the following advantages.

The implementations relate to methods, devices, and systems for processing mobile application pages and/or updating mobile application pages on a client terminal. The implementations use a preset page protocol configuration for mobile applications. In other words, the implementations use various page components and page protocols of the preset page protocol configuration to allow the mobile application page to include page components and a page layout and then to facilitate a server terminal to release a new page.

In these instances, a mobile client terminal parses protocols of parsing engines, rendering and display the page expressed using the preset page protocol configuration.

The implementations may achieve the following results.

1) The preset page protocol is similar to traditional WEB pages developed using HTML/CSS development with respect to syntax and semantics. Developers do not need to learn professional knowledge of a client terminal and will be able to develop a mobile application. Costs for developing an application is similar to the costs for developing an application including a web page. This reduces development costs.

2) Releasing a new page of an application on a server terminal will change the whole content of the application on the client terminal. This avoids the need to publish a new upgrade of the application package for users to download, and thus greatly accelerates the speed of upgrading. Users may experience the newest version of the page after the page is released on the server terminal.

3) The client terminal converts the page to local code page and receives the service after the page is converted by the client protocol parsing engine to a local code page. Thus, user experience has not been changed, and experience and performance of native applications are maintained.

4) As compared with the native applications, page components and templates for page composition are transparent to clients. The nature of the page components and template are page protocols. Therefore, the clients only need to deal with the page protocols to parse the page. The page components and templates can be infinitely extended on the basis of the page protocols of the page such as to dynamically adding page components and templates.

5) The same pages may be displayed by different platforms (e.g., iOS, Android, and H5) so as to achieve the effect of cross-platform. This avoids development and maintenance of a plurality of different operating systems for application codes, and thus effectively reduces workload of program development and maintenance.

In sum, the implementations enable mobile application pages to be developed in low cost and to have good user experience similar to those of native applications.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for processing mobile application pages.

FIG. 2 is a flow chart of an illustrative process prior to the operation 110 described in FIG. 1.

FIG. 3 is a flow chart of an illustrative process for the operation 110 described in FIG. 1.

FIG. 4 is schematic diagrams of an illustrative device for processing mobile application pages.

FIG. 5 is a flow chart of an illustrative process for updating mobile application pages on a client terminal.

FIG. 6 is a flow chart of an illustrative process for the operation 504 described in FIG. 5.

FIG. 7 is a flow chart of an illustrative process for downgrading and making compatible prior to the operation 512 described in FIG. 5.

FIG. 8 is a flow chart of an illustrative process for configuring mobile application pages.

FIG. 9 is schematic diagrams of an illustrative device for updating mobile application pages.

FIG. 10 is schematic diagrams of an illustrative system for processing mobile application pages.

### DETAILED DESCRIPTION

In the following description, numerous specific details are set forth in order to fully understand the present disclosure. However, the present disclosure can be implemented in many other ways than those herein expressed in embodiments, those skilled in the art can make similar promotion without departing from the present application connotation case; therefore the present disclosure is not limited the particular embodiment disclosed below.

Implementations herein relate to mobile applications-related work including development of mobile applications, publication and operation. A mobile application is an application including a plurality of user interface. Therefore, development, publishing and operating mobile applications may be implemented by interacting with these user interfaces.

The implementations relate to methods, devices, and systems for processing mobile application pages and/or updating mobile application pages on a client terminal.

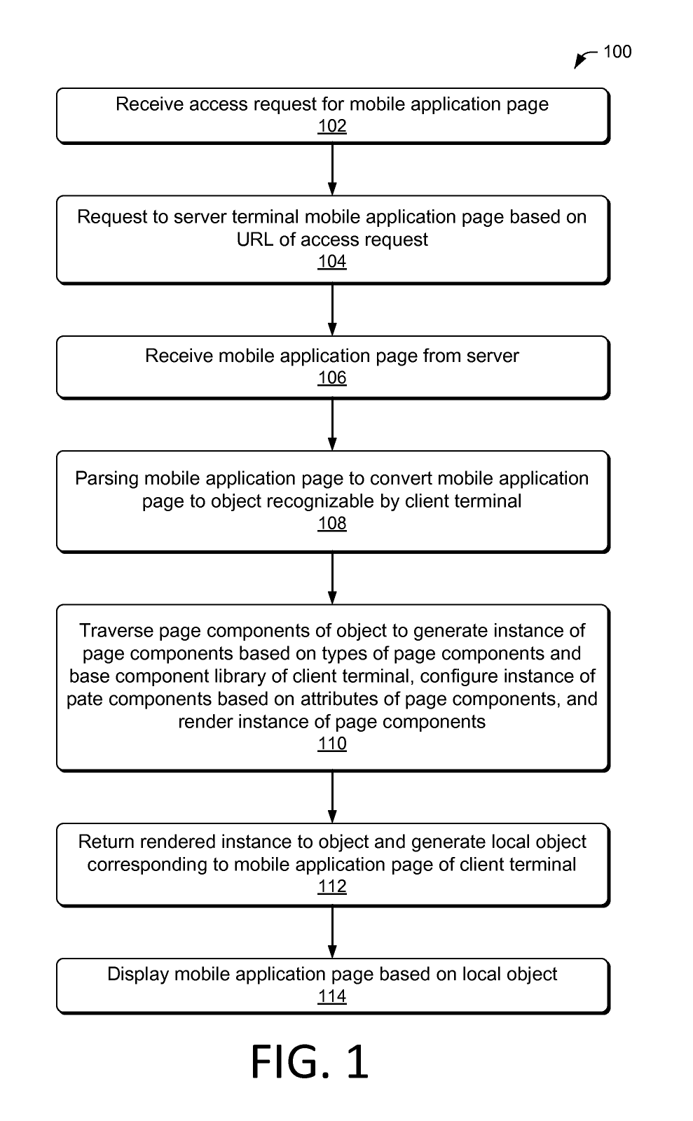

FIG. 1 is a flow chart of an illustrative process 100 for processing mobile application pages. At 102, a computing device (e.g., a mobile device) may receive an access request for a mobile application page.

At 104, the computing device may request to a server terminal the mobile application page based on a uniform resource locator (URL) of the access request.

The implementations include a method for processing mobile application pages. A client terminal may intercept a Uniform Resource Locator (URL), and transmit the URL to a server terminal. The sever terminal may parse the URL to obtain a page identifier. Based on the page identifier, the server terminal may locate protocol data of a page.

In implementations, the URL may include a name of the mobile application page, a namespace of the mobile application page, and/or a user account of the mobile application page. A namespace is in the form of a page organization. For example, using the namespace, pages may be classified based on functions of these pages. Also, the namespace is a part of full names of all the pages associated with the mobile application. A full name of a page may include at least a namespace that the page belongs to and a name of the page. For example, pages having the same name but under different namespaces are different pages.

For example, the URL may include a name of the mobile application page, a namespace of the mobile application page, and/or a user account of the mobile application page. For example, the URL includes “namespace=shop”, “path=index”, “user=12345.” In these instances, “namespace” value indicates the namespace that page belongs to, “path” value indicates the name of the page, and “user” value indicates the user account that the page belongs to. Based on the information above, the server terminal may locate the home page of the seller “12345,” for example in a website associated with an electronic commerce service provider.

At 106, the computing device may receive the mobile application page from the server terminal. The mobile application page may include a page layout and page components. The mobile application page may include a page using a Json data exchange format or a XML markup extension language. The page layout indicates a format configuration of the page. The page components may include component elements.

For example, a page using the XML markup extension language may be illustrated as follow.

```
    <!-- component-telephone -->
    <container>
        <!-- layout -->
        <layout type=“absoluteLayout”/>
        <!-- edit attribute -->
        <editProperty moduleType=“phone”>
            <dataDefines>
                <dataDefine name=“phone_number” type=
“text” validateType=“num” description=“please enter telephone text”
contentSize=“13”/>
            </dataDefines>
        </editProperty>
        <!-- type binding -->
        <styleBinding>
            <attribute name=“width” value=“−1”/>
            <attribute name=“height” value=“104”/>
            <attribute name=“marginBottom” value=“24”/>
            <attribute name=“backgroundColor” value=“#FFFFFF”/>
        </styleBinding>
        <subViews>
            <!-telephone icon -->
            <image url=“http:
//gtms02.alicdn.com/tps/i2/T1kZOKFtdcXXaeHbsb-100-100.png”>
                <styleBinding>
                    <attribute name=“width” value=“40”/>
                    <attribute name=“height” value=“40”/>
                    <attribute name=“align” value=“4”/>
                    <attribute name=“marginLeft” value=“26”/>
                </styleBinding>
            </image>
            <!-- telephone number -->
            <label value=“$phone_number” lines=“1”>
                <styleBinding>
                    <attribute name=“width” value=“−1”/>
                    <attribute name=“height” value=“84”/>
                    <attribute name=“align” value=“4”/>
                    <attribute name=“marginLeft” value=“86”/>
                    <attribute name=“fontSize” value=“28”/>
                    <attribute name=“textColor” value=“#3d3f45”/>
                    <attribute name=“fontStyle” value=“1”/>
                    <attribute name=“gravity” value=“4”/>
                </styleBinding>
            </label>
        </subViews>
        <!-clicking event -->
        <events>
            <event type=“click”>
                <actions type=“phoneCall”>
                    <phoneCall phoneNumber=“$phone_number”/>
                </actions>
            </event>
        </events>
    </container>
```

For instance, a page using the Json data exchange format may be illustrated as follow.

```
{
  “view”: {
    “editProperty”: {
      “dataDefines”: [
        {
          “contentSize”: 13,
          “description”: “please enter telephone text”,
          “isNull”: false,
          “name”: “phone_number”,
          “propertyName”: “telephone number”,
          “type”: “text”,
          “validateType”: “phone”
        }
      ],
      “moduleType”: “phone”
    },
    “events”: [
      {
        “actions”: [
          {
            “param”: {
              “utName”: “TelPhone”,
              “utParams”: {
                “wp_m”: “MODULE_KEY_PLACE_HOLDER”,
                “wp_pk”: “$wp_pk”
              },
              “utType”: “Button”
            },
              “type”: “userTrack”
            },
            {
              “param”: {
                “phoneNumber”: “$phone_number”
              },
              “type”: “phoneCall”
            }
          ],
          “type”: “click”
        }
      ],
      “styleBinding”: {
        “backgroundColor”: “#FFFFFF”,
        “borderColor”: “#dddddd”,
        “borderWidth”: 1,
        “height”: 104,
        “layout”: “absoluteLayout”,
        “marginBottom”: 24,
        “width”: −1
      },
      “subViews”: [
        {
          “dataBinding”: {
            “url”: “http: //gtms02.alicdn.com/tps/i2/
T1kZOKFtdcXXaeHbsb-100-100.png”
          },
          “styleBinding”: {
          “align”: 4,
          “height”: 40,
          “marginLeft”: 26,
          “width”: 40
        },
        “type”: “image”
      },
      {
        “dataBinding”: {
          “value”: “$phone_number”
        },
        “styleBinding”: {
          “align”: 4,
          “fontSize”: 28,
          “fontStyle”: 1,
          “gravity”: 4,
          “height”: 84,
          “lines”: 1,
          “marginLeft”: 86,
          “textColor”: “#3d3f45”,
          “width”: −3.
        },
        “type”: “label”
      }
    ],
    “type”: “container”
  }
}
```

As described above, the page components using XML markup extension language and using the Json data exchange format are the same page component: a telephone component. Between these two formats, the page using the Json data exchange format is straighter to engine parsing protocols on the client terminal. Therefore, the server terminal generally adopts the Json data exchange format for rendering pages and returns the pages to the client terminal. Pages using XML markup extension language are generated for developers who develop pages.

At 108, the computing device may parse the mobile application page to convert the mobile application page to an object recognizable by the client terminal. For pages using XML markup extension language, the computing device may parse the mobile application page to convert the mobile application page to an object recognizable by a client terminal by parsing the page in the XML markup extension language to convert the page to the page recognizable by the client terminal.

In implementations, pages using Json data exchange format may be used. Accordingly, the computing device may parse the mobile application page to convert the mobile application page to an object recognizable by a client terminal by parsing the page in the Json data exchange format to convert the page to the object recognizable by the client terminal.

The object recognizable by the client terminal may include a logic unit of a local compiling model of the client terminal. A page described using the Json data exchange format essentially is a plain text file. Thus, to parse the file, elements of all levels of the file are converted to objects recognizable by the client terminal for the remaining procedure.

At 110, the computing device may traverse the page components of the object to generate an instance of each of the page components based on one or more types of the one of the page components and a base component library of the client terminal, configure the instance of the pate components based on one or more attributes of the one of the page components, and render the instance.

In implementations, as a prerequisite to generate the instance of each of the page components, all the categories of the page components are stored in the base component library of the client terminal. An engine parsing protocol on the client terminal may acquire a category corresponding to the page components from the base component library to generate the instance of one of the page components based on the type of the one of the page components.

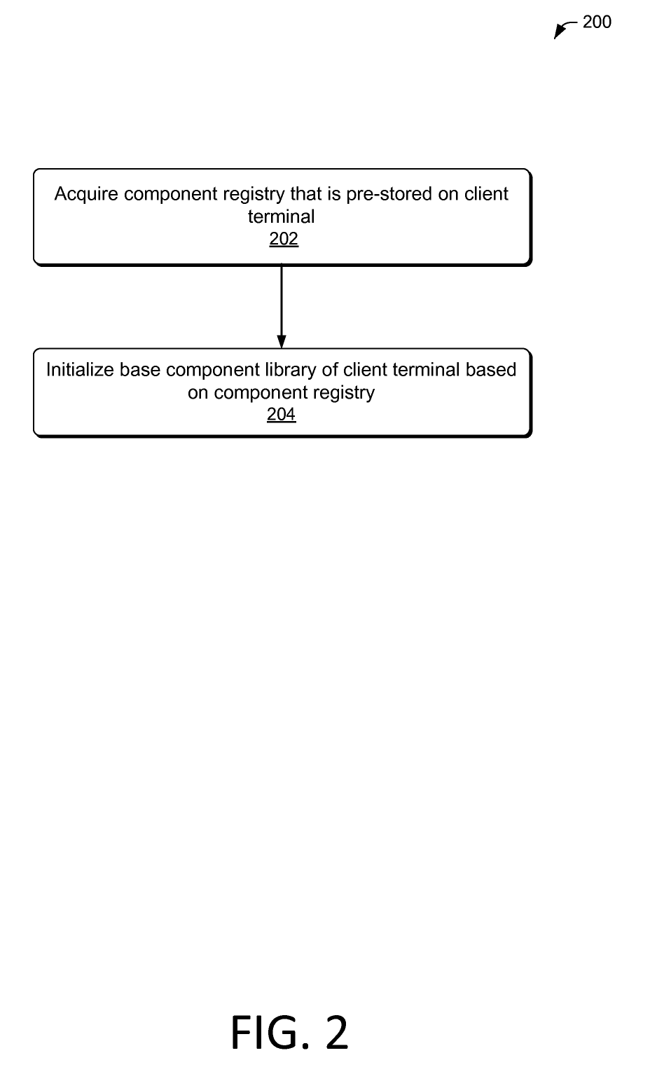

FIG. 2 is a flow chart of an illustrative process 200 prior to the operation 110 described in FIG. 1. At 202, the computing device may acquire a component registry that is pre-stored on the client terminal.

At 204, the computing device may initialize the base component library of the client terminal based on the component registry. The component registry may indicate a corresponding relationship between a type of a base component and a category of the base component. For example, the component registry may be shown in Table 2.

TABLE 2
Component registry

| Type | Category |
|---|---|
| slide | Custom Components |
| image | Replaceable default components |

Base components of the implementations are similar to HTML tags. The base component may include a button component, an image component, a labeling component, and a text component. Corresponding to HTML tags, the base component library may further include a form component, a navigation linking component, and an option component.

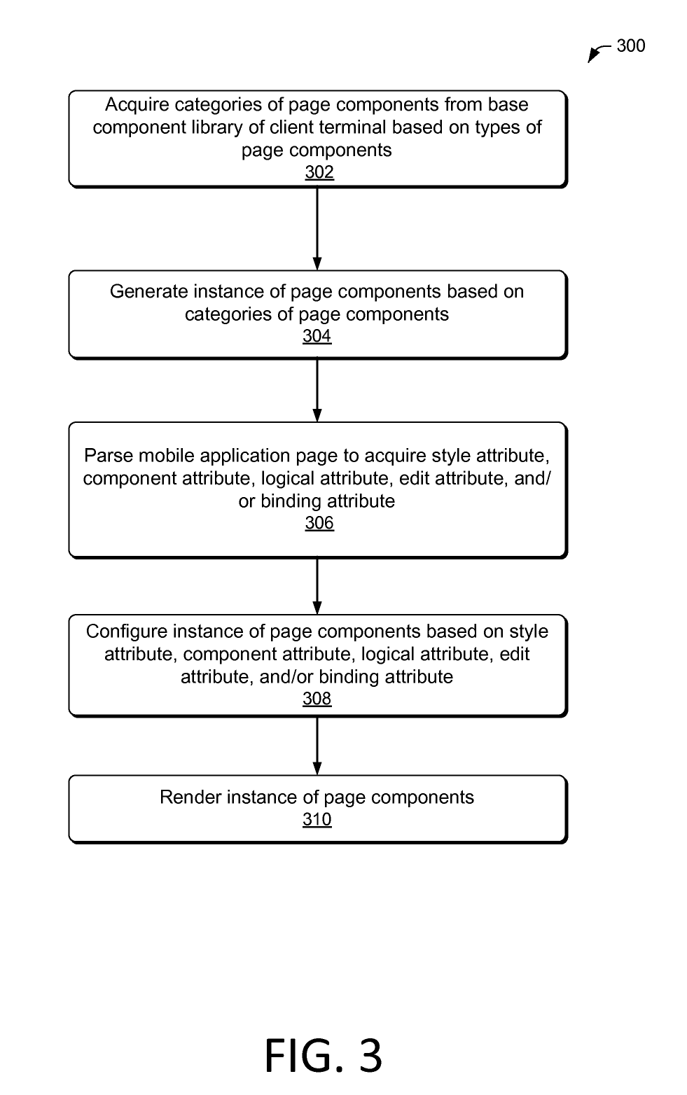

FIG. 3 is a flow chart of an illustrative process 300 for the operation 110 described in FIG. 1. In some implementations, prior to generating an instance each of the page components based on one or more types of the one of the page components and a base component library of the client terminal, the computing device may acquire categories of the page components from the base component library of the client terminal based on the types of the page components at 302.

At 304, the computing device may generate the instance of each of page components based on the category of the one of the page components.

In implementations, the one or more attributes of the page components may include a style attribute, a component attribute, a logical attribute, an edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component. The component attribute may include a character description of a component. For example, the component attribute of a photo component is an address of a photo indicated by a URL.

The style attribute may include a style description (e.g., CSS) of the component including a width, a height, and/or color. The logical attribute may include control statements supported by the component including conditional statements and/or loop execute statements (e.g., condition, if, and else). The edit attribute may include protocols interacting with editors and main content agreed upon dataDefines to follow while editing. For example, a photo component may use up to five editing rules. The binding attribute may include a form of dynamic data in the page protocol. Return data may be filled in a corresponding position via a HTTP request.

In implementations, binding methods of dynamic data of the binding attribute may include dynamical binding, static binding, and dependent binding. For example, API binding: an interface for dynamic data acquisition, static data: data filled up when users configure the page, and data reference: data-dependent rendering is performed using a method similar to velocity.

In implementations, the computing device may configure the instance of the pate components based on one or more attributes of the page components by parsing the mobile application page to acquire the style attribute, the component attribute, the logical attribute, the edit attribute, and/or the binding attribute at 306, and configuring the instance of the one of the page components based on the style attribute, the component attribute, the logical attribute, the edit attribute, and/or the binding attribute at 308.

At 310, the computing device may render the instance of the one of the page components.

Referring back to FIG. 1, the computing device may return the rendered instance to the object and generating a local object corresponding to the mobile application page on the client terminal at 112.

At 114, the computing device may display the mobile application page based on the local object.

The implementations relate to a method for processing mobile application pages. The method may convert the mobile application page indicated by a page layout and page components to an object recognizable by a client terminal. The method includes traversing, by a computing device, an individual page component of the object recognizable by the client terminal and generating an instance of each of the page components based a type of the one of the page components and a base component library of the client terminal. The computing device may further configure the instances of the pate components based on one or more attributes of the page components, render the instances of the page components, and return the rendered instances to the object and generating a local object corresponding to the mobile application page on the client terminal. Thus, the client terminal may display the mobile application page including a page layout and page components.

The implementations include a device corresponding to the method for processing mobile application pages described above. Since the device of the embodiment is substantially similar to the described method example, it is describe referring to part of the method embodiment of the instructions. The following descriptions of the embodiments are merely illustrative.

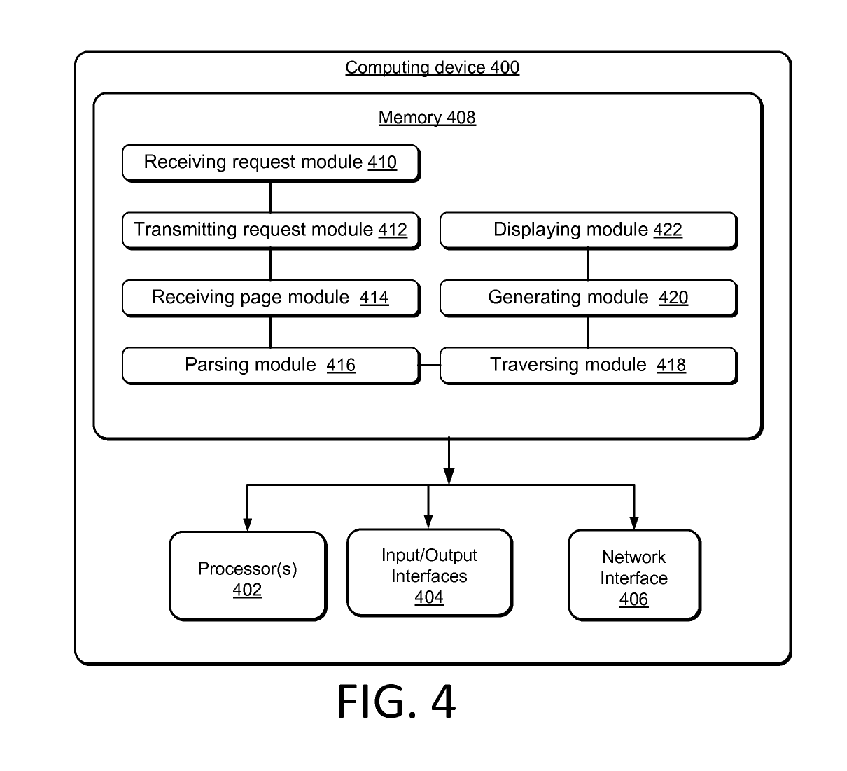

FIG. 4 is schematic diagrams of an illustrative device 400 for processing mobile application pages. The computing device 400 may be a user device or a server for processing mobile application pages. In an exemplary configuration, the computing device 400 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a receiving request module 410, a transmitting request module 412, a receiving page module 414, a parsing module 416, a traversing module 418, a generating module 420, and a displaying module 422.

The receiving request module 410 may be configured to receive an access request for a mobile application page. The transmitting request module 412 may be configured to request to a server the mobile application page based on a URL of the access request. The receiving page module 414 may be configured to receive the mobile application page from the server; the mobile application page including a page layout and page components. The parsing module 416 may be configured to parse the mobile application page to convert the mobile application page to an object recognizable by a client terminal. The traversing module 418 may be configured to traverse an individual page component of the object recognizable by the client terminal and generating an instance of each of the page components based on a type of the one of the page components and a base component library of the client terminal, configure the instance of the one of the pate components based on one or more attributes of the one of the page components, and render the instance of the one of the page components.

The generating module 420 may be configured to return the rendered instance to the object and a local object corresponding to the mobile application page on the client terminal. The displaying module 422 may be configured to display the mobile application page based on the local object.

In implementations, the memory 408 may further include an acquiring registry module configured to acquire a component registry that is pre-stored on the client terminal, an initialization component library module configured to initialize the base component library of the client terminal based on the component registry. In these instances, the component registry may indicate a corresponding relationship between a type of a base component and a category of the base component. The base component may include a button component, an image component, a labeling component, and a text component.

For instance, the mobile application page may include a page expressed using a Json data exchange format or a XML markup extension language. Accordingly, the device 400 may parse the mobile application page to convert the mobile application page to an object recognizable by a client terminal by parsing the page in the Json data exchange format to convert the page to the object recognizable by the client terminal or parsing the page in the XML markup extension language to convert the page to the page recognizable by the client terminal.

In implementations, the memory 408 may further include a generating component instance module configured to generate an instance of each of the page components based on a type of the one of the page components and a base component library of the client terminal. In these instances, the generating component instance module may include a acquiring component class submodule configured to acquire categories of the page components from the base component library of the client terminal based on the types of the page components, and a generating component instance submodule configured to generate the instance of page components based on the categories of the page components.

For instance, the one or more attributes of the page components may include a style attribute, a component attribute, a logical attribute, a edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

In implementations, the memory 408 may further include a configuration component module configured to configure the instance of the pate components based on one or more attributes of the page components. In these instances, the configuration component module may include a acquiring property submodule configured to parse the mobile application page to acquire the style attribute, the component attribute, the logical attribute, the edit attribute, and/or the binding attribute, a configuration component submodule configured to configure the instance of the one of the page components based on the style attribute, the component attribute, the logical attribute, the edit attribute, and/or the binding attribute. For example, a binding method of dynamic data of the binding attribute may include dynamical binding, static binding, and dependent binding.

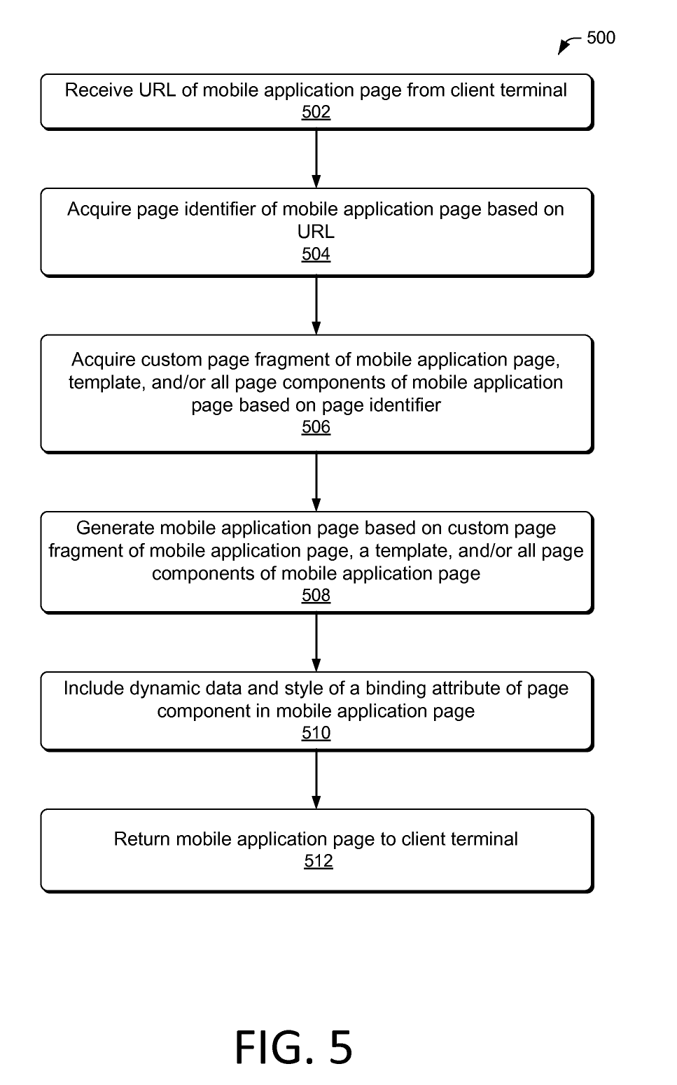

The implementations include a method for updating mobile application pages corresponding to the method for processing mobile application pages on a client terminal. FIG. 5 is a flow chart of an illustrative process 500 for updating mobile application pages on a client terminal.

At 502, a computing device (e.g., a server) may receive a URL of a mobile application page from a client terminal.

At 504, the computing device may acquire a page identifier of the mobile application page based on the URL. In implementations, the computing device may acquire a page identifier of the mobile application page based on the URL by the server terminal via external and internal routes. The page identifier may locate an individual record in the database.

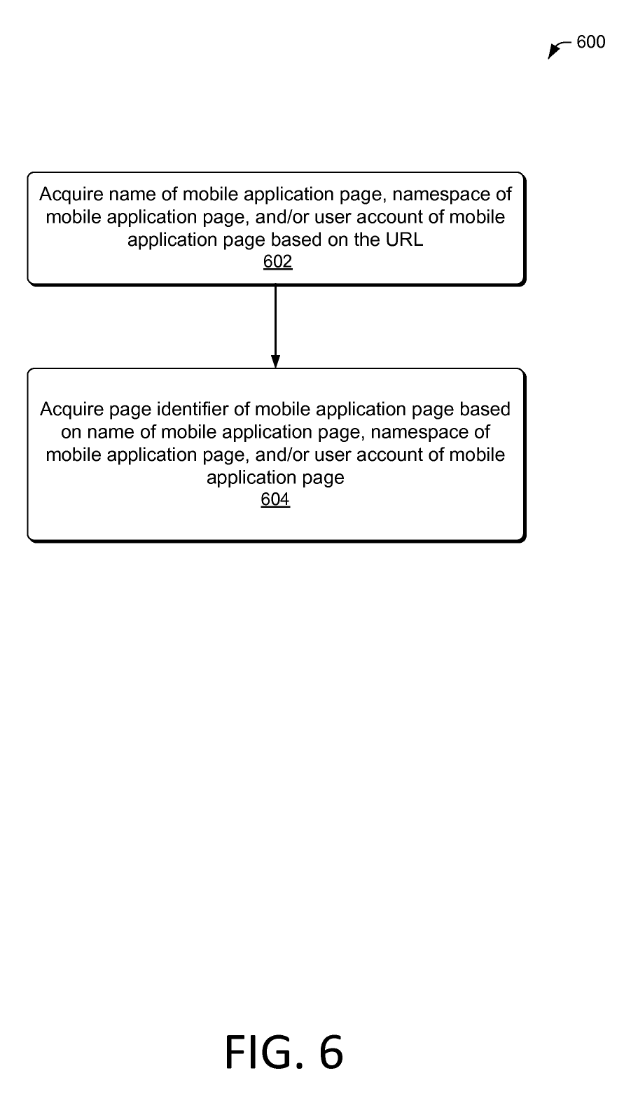

FIG. 6 is a flow chart of an illustrative process 600 for the operation 504 described in FIG. 5. The computing device may acquire a page identifier of the mobile application page based on the URL by acquiring the name of the mobile application page, the namespace of the mobile application page, and/or the user account of the mobile application page based on the URL at 602, and by acquiring a page identifier of the mobile application page based on the name of the mobile application page, the namespace of the mobile application page, and/or the user account of the mobile application page at 604.

In implementations, the URL may include a name of the mobile application page, a namespace of the mobile application page, and/or a user account of the mobile application page. The URL may include a name of the mobile application page, a namespace of the mobile application page, and/or a user account of the mobile application page. For example, the URL includes “namespace=shop”, “path=index”, “user=12345.” In these instances, “namespace” value indicates the namespace that page belongs to, “path” value indicates the name of the page, and “user” value indicates the user account that the page belongs to. In the above scenario, based on the information above, the server terminal may locate the home page of the seller “12345.”

In implementations, the computing device may acquire a page identifier of the mobile application page based on the URL by determining whether to use an evaluation template or an evaluation page to the mobile application page based on the page identifier of the mobile application page and a configuration file of a A/B test that is preset on a server terminal. In response to using the evaluation template or the evaluation page, the computing device may designate a template identifier of the evaluation template or a page identifier of the evaluation page as the page identifier of the mobile application page.

A/B test is a new page optimization method. A/B test may be used to increase conversion rates, enrollment rates, and other web indicators. A/B test includes a separate set of experiments. Previously, technology and resource costs of A/B test are relatively high. But now with a series of professional visualization experiment tools, A/B test has become a common method of website optimization. A configuration file of A/B test indicates displaying different pages based on different needs. For example, when a page is displayed, specific pages of different styles may be displayed based on the requesting user's gender.

Referring back to FIG. 5, the computing device (e.g., a server) may acquire a custom page fragment of the mobile application page, a template, and/or all page components of the mobile application page based on the page identifier at 506.

In implementations, the content of the mobile application page including a custom page fragment of the mobile application page, a template, and/or all page components of the mobile application page. One page may include a plurality of custom page fragments, a template, and/or a plurality of page components. The custom page fragment of the mobile application page, the template, and/or all page components of the mobile application page are expressed using a Json data exchange format or a XML markup extension language. The custom page fragment of the mobile application page, the template, and/or the all page components of the mobile application page are stored in a database.

At 508, the computing device may generate the mobile application page based on custom page fragment of the mobile application page, a template, and/or all page components of the mobile application page. The mobile application page may include a page expressed using a Json data exchange format or a XML markup extension language.

In implementations, the one or more attributes of the page components may include a style attribute, a component attribute, a logical attribute, an edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

At 510, the computing device may include dynamic data and a style of a binding attribute of a page component in the mobile application page.

At 512, the computing device may return the mobile application page to the client terminal. The mobile application page may include a page layout and page components

In implementations, prior to returning the mobile application page to the client terminal, the computing device may convert the mobile application page to a page expressed in a Json data exchange format or a XML markup extension language.

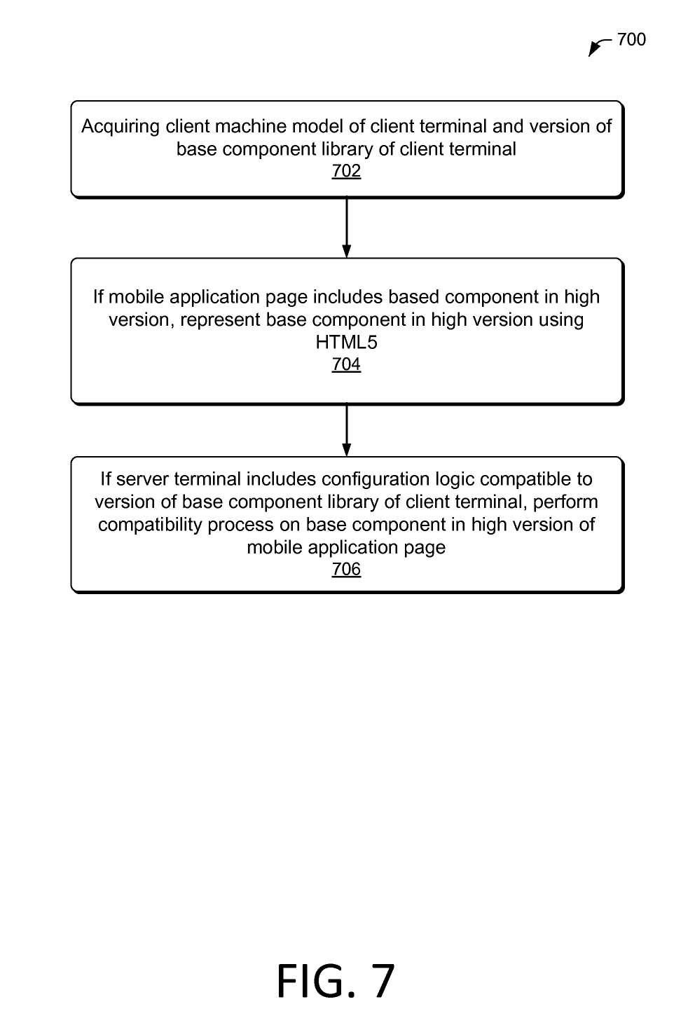

In implementations, between these two formats, the page using the Json data exchange format is straighter to an engine parsing protocols on the client terminal. Therefore, the server terminal generally adopts the Json data exchange format for rendering pages and returning the pages to the client terminal. Pages using XML markup extension language are generated for developers who develop pages. Because the base component library of the server terminal may be higher than the base component library of the client end, operations illustrated in FIG. 7 may be performed prior to the operation 512.

FIG. 7 is a flow chart of an illustrative process 700 for downgrading and making compatible prior to the operation 512 described in FIG. 5. Prior to returning the mobile application page to the client terminal, the computing device may determine whether the mobile application page includes a base component in a high version that is not supported by the base component library of the client terminal based on a version of the base component library of the client terminal.

If the mobile application page includes the base component in the high version, a computing device may represent the base component in the high version using HTML5 at 704. In some implementations, the representing the base component in the high version using HTML5 may include converting the base component in the high version to a HTML representation using WebView.

In implementations, prior to returning the mobile application page to the client terminal, the computing device may acquire a client machine model of the client terminal and a version of the base component library of the client terminal at 702, and determine whether a server terminal includes a configuration logic compatible to the version of the base component library of the client terminal based on client machine model of the client terminal and a version of base component library of the client terminal.

If the server terminal includes the configuration logic compatible to the version of the base component library of the client terminal, the computing device may perform a compatibility process on the base component in the high version of the mobile application page based on the configuration logic to convert the base component to a base component recognizable by the client terminal at 706.

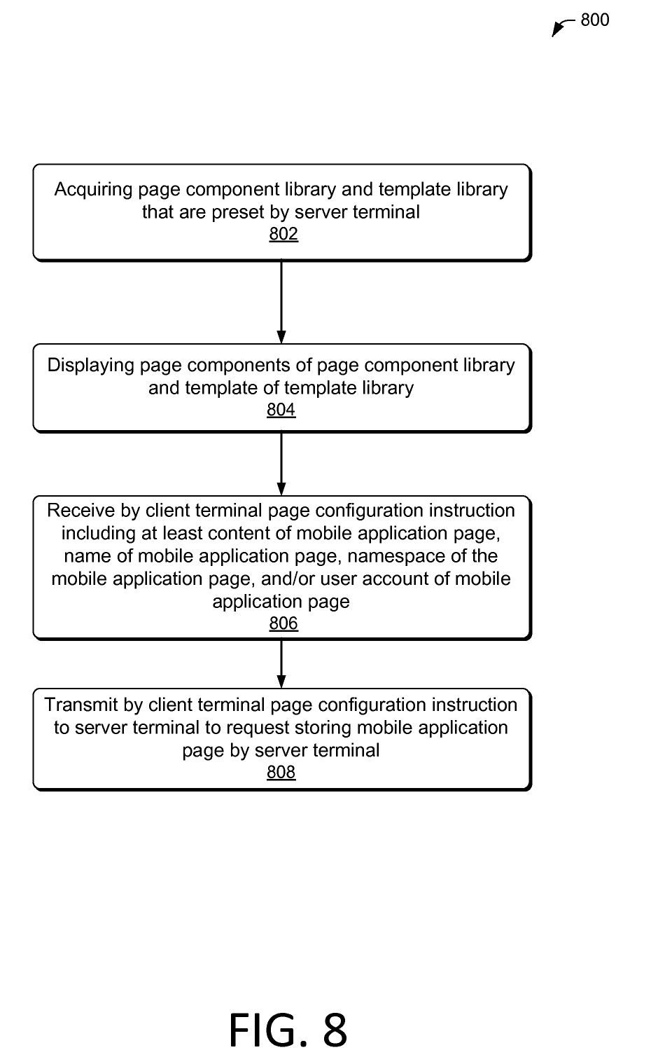

FIG. 8 is a flow chart of an illustrative process 800 for configuring mobile application pages. In implementations, the mobile application may be configured to receive by the client terminal a page configuration instruction including at least content of the mobile application page, a name of the mobile application page, a namespace of the mobile application page, and/or a user account of the mobile application page at 806. The content of the mobile application page may include a custom page fragment of the mobile application page, a template, and/or all page components of the mobile application page;

The mobile application may be configured to further transmit by the client terminal the page configuration instruction to the server terminal to request storing the mobile application page by the server terminal at 808.

The computing device may store the mobile application page by the server terminal by receiving the page configuration instruction from the client terminal, acquiring content of the mobile application page, a name of the mobile application page, a namespace of the mobile application page, and/or a user account of the mobile application page based on the page configuration instruction, generating a page identifier of the mobile application page based on the name of the mobile application page, the namespace of the mobile application page, and/or the user account of the mobile application page, and storing the page identifier and the content of the mobile application page. In some implementations, the page identifier and the content of the mobile application page are stored in a database.

In implementations, prior to receiving the page configuration instruction by the client terminal, the computing device may acquire a page component library and a template library that are preset by the server terminal at 802, and displaying all the page components of the page component library and all the template of the template library at 804.

In implementations, the computing device may further acquire a custom page fragment of the mobile application page, a template, and/or all page components of the mobile application page based on the page identifier, generate the mobile application page based on custom page fragment of the mobile application page, a template, and/or all page components of the mobile application page, and include dynamic data and a style of a binding attribute of a page component in the mobile application page such that the server terminal may generate the mobile application page including the page layout and the page components and return the mobile application page to the client terminal.

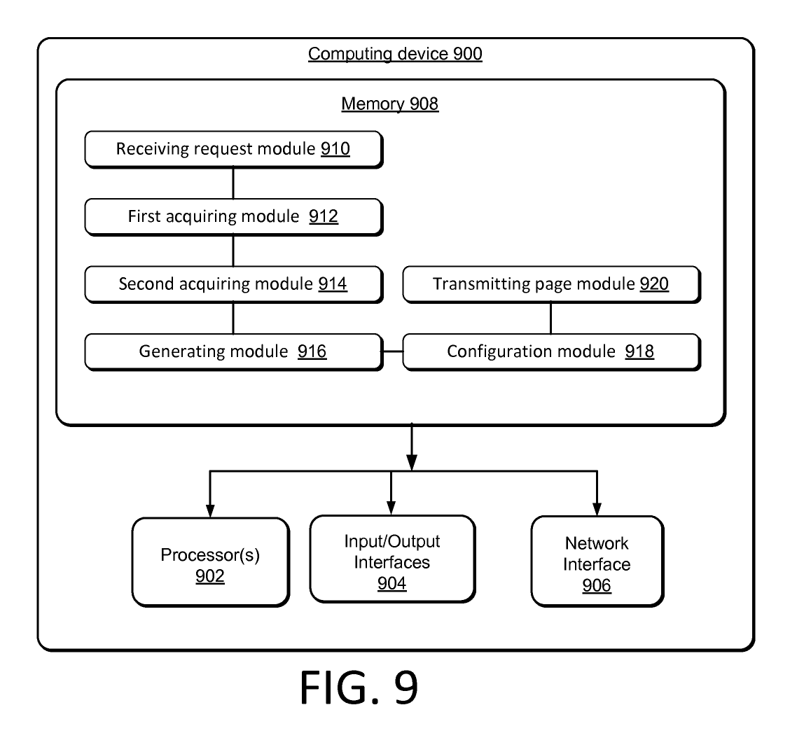

The implementations include a device corresponding to the method for updating mobile application pages on a client terminal. FIG. 9 is schematic diagrams of an illustrative device 900 for updating mobile application pages. The computing device 900 may be a user device or a server for updating mobile application pages. In one exemplary configuration, the computing device 900 includes one or more processors 902, input/output interfaces 904, network interface 906, and memory 908.

The memory 908 may include computer-readable media in the form of volatile memory, such as random-access memory (RAM) and/or non-volatile memory, such as read only memory (ROM) or flash RAM. The memory 908 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 908 in more detail, the memory 908 may include a receiving request module 910, a first acquiring module 912, a second acquiring module 914, a generating module 916, a configuration module 918, and a transmitting page module 920.

The receiving request module 910 may be configured to receive a URL of a mobile application page from a client terminal. The first acquiring module 912 may be configured to acquire a page identifier of the mobile application page based on the URL. The second acquiring module 914 may be configured to acquire a custom page fragment of the mobile application page, a template, and/or all page components of the mobile application page based on the page identifier. The generating module 916 may be configured to generate the mobile application page based on custom page fragment of the mobile application page, a template, and/or all page components of the mobile application page. The configuration module 918 may be configured to include dynamic data and a style of a binding attribute of a page component in the mobile application page. The transmitting page module 920 may be configured to receive the mobile application page from the server. In these instances, the mobile application page may include a page layout and page components. For instance, the URL may include a name of the mobile application page, a namespace of the mobile application page, and/or a user account of the mobile application page.

In implementations, the first acquiring module 912 may include a acquiring business semantics submodule configured to acquire the name of the mobile application page, the namespace of the mobile application page, and/or the user account of the mobile application page based on the URL, and an acquiring page identifier submodule configured to acquire a page identifier of the mobile application page based on the name of the mobile application page, the namespace of the mobile application page, and/or the user account of the mobile application page.

In implementations, the memory 908 may further include an A/B testing module configured to determine whether to use an evaluation template or an evaluation page to the mobile application page based on the page identifier of the mobile application page and a configuration file of an A/B test that is preset on a server terminal. In response to using the evaluation template or the evaluation page, the computing device 900 may designate a template identifier of the evaluation template or a page identifier of the evaluation page as the page identifier of the mobile application page.

For instance, the custom page fragment of the mobile application page, the template, and/or all page components of the mobile application page are expressed using a Json data exchange format or a XML markup extension language.

For instance, the mobile application page may include a page using a Json data exchange format or a XML markup extension language. The one or more attributes of the page components may include a style attribute, a component attribute, a logical attribute, an edit attribute, and/or a binding attribute. The component attribute may include a character description of a component. The style attribute may include a style description of the component including a width, a height, and/or color. The logical attribute may include control statements supported by the component including conditional statements and/or loop execute statements. The edit attribute may include an editing rule of the component. The binding attribute may include an event, animation, dynamic data, style, and/or bury point data that are bound to the component.

For instance, the custom page fragment of the mobile application page, the template, and/or the all page components of the mobile application page are stored in a database.

In implementations, the memory 908 may further include a format converting module configured to convert the mobile application page to a page in a Json data exchange format or a XML markup extension language.

In implementations, the memory 908 may further include a downgrade module configured to determine whether the mobile application page includes a base component in a high version that is not supported by the base component library of the client terminal based on a version of the base component library of the client terminal;

If the mobile application page includes the base component in the high version, the computing device 900 may represent the base component in the high version using HTML5. For instances, the representing the base component in the high version using HTML5 may include converting the base component in the high version to a HTML representation using WebView.

In implementations, the memory 908 may further include a third acquisition module configured to acquire a client machine model of the client terminal and a version of the base component library of the client terminal.

In implementations, the memory 908 may further include a patching module configured to determine whether a server terminal includes a configuration logic compatible to the version of the base component library of the client terminal based on client machine model of the client terminal and a version of base component library of the client terminal;

If the server terminal includes the configuration logic compatible to the version of the base component library of the client terminal, the computing device 900 may perform a compatibility process on the base component in the high version of the mobile application page based on the configuration logic to convert the base component to a base component recognizable by the client terminal.

In implementations, the memory 908 may further include a configuration page module configured to configure the mobile application page. In these instances, the configuration page module may include a receiving instruction module configured to receive by the client terminal a page configuration instruction including at least content of the mobile application page, a name of the mobile application page, a namespace of the mobile application page, and/or a user account of the mobile application page. The content of the mobile application page may include a custom page fragment of the mobile application page, a template, and/or all page components of the mobile application page.

In implementations, the memory 908 may further include a request storage module configured to transmit the page configuration instruction to the server terminal to request storing the mobile application page by the server terminal.

In implementations, the memory 908 may further include an acquiring library module configured to acquire a page component library and a template library that are preset by the server terminal.

In implementations, the memory 908 may further include an acquiring component template module configured to display all the page components of the page component library and all the template of the template library.

In implementations, the memory 908 may further include a storing page module configured to store the mobile application page on the server terminal. In these instances, the storing page module may include a receiving sub module configured to receive the page configuration instruction from the client terminal, an acquisition submodule configured to acquire content of the mobile application page, a name of the mobile application page, a namespace of the mobile application page, and/or a user account of the mobile application page based on the page configuration instruction, a generating submodule configured to generate a page identifier of the mobile application page based on the name of the mobile application page, the namespace of the mobile application page, and/or the user account of the mobile application page, and a storing submodule configured to store the page identifier and the content of the mobile application page. The page identifier and the content of the mobile application page are stored in a database.

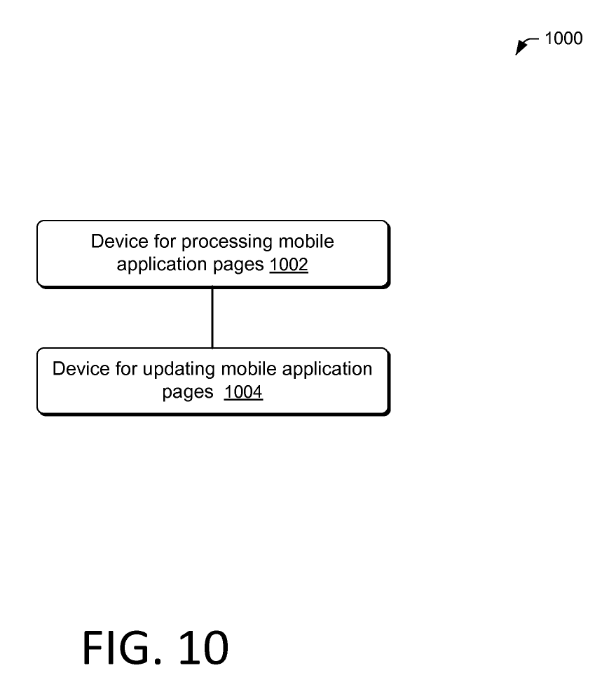

The implementations include a system for processing mobile application pages. FIG. 10 is a schematic diagram of an illustrative system 1000 for processing mobile application pages. The system may include a device 1002 and a device 1004. The device 1004 for updating mobile application pages on the client terminal may be deployed on a server or other devices. The device 1002 for processing mobile application pages may be deployed on mobile devices. For example, a smart phone may upload a URL and request from a server a page.

The system 1000 may convert the mobile application page indicated by a page layout and page components to an object recognizable by a client terminal. The system 1000 may then traverse an individual page component of the object recognizable by the client terminal and generate an instance of each of the page components based on a type of the one of the page components and a base component library of the client terminal.

The system 1000 may configure the instances of the pate components based on one or more attributes of the page components, render the instances of the page components, and return the rendered instances to the object and generating a local object corresponding to the mobile application page on the client terminal. Thus, the client terminal may display the mobile application page including a page layout and page components.

The device 1004 for updating mobile application pages may be deployed on a server. The system 1000 may acquire a custom page fragment of the mobile application page, a template, and/or all page components of the mobile application page based on the page identifier. The system 1000 may generate the mobile application page based on custom page fragment of the mobile application page, a template, and/or all page components of the mobile application page, include dynamic data and a style of a binding attribute of a page component in the mobile application page such that the server terminal may generate the mobile application page including the page layout and the page components and return the mobile application page to the client terminal.

The implementations relate to methods, devices, and systems for processing mobile application pages and/or updating mobile application pages on a client terminal. In other words, the implementations use various page components and page protocols of a preset page protocol configuration to allow the mobile application page to include page components and a page layout, and then facilitate a server terminal to release a new page.

In these instances, a mobile client terminal parses protocols of parsing engines, rendering and displaying the page using the preset page protocol configuration to achieve one or more of the following effects.

1) The preset page protocol is similar to traditional WEB pages developed using HTML/CSS development with respect to syntax and semantics. Developers do not need to learn professional knowledge of a client terminal and will be able to develop a mobile application. Costs for developing an application are similar to the costs for developing an application including a web page. This reduces development costs.

2) Releasing a new page of an application on a server terminal will change the whole content of the application on the client terminal. This avoids the need to publish a new upgrade of the application package for users to download, and thus greatly accelerates the speed of upgrading. Users may experience the newest version of the page after the page is released on the server terminal.

3) The client terminal converts the page to local code page receives the service after the page is converted by the client protocol parsing engine to a local code page. Thus, user experience has not been changed and experience and performance of native applications are maintained.

4) As compared with the native applications, page components and templates for page composition are transparent to clients. The nature of the page components and the template are page protocols. Therefore, the clients only need to deal with the page protocols to parse the page. The page components and templates can be infinitely extended on the basis of the page protocols on the page such as to dynamically add page components and templates.

5) The same pages may be displayed by three different platforms (e.g., iOS, Android, and H5) so as to achieve the effect of cross-platform. This avoids development and maintenance of a plurality of different operating systems for application codes, and thus effectively reduces workload of program development and maintenance.

In sum, the implementations enable mobile application pages to be developed in low cost and to have good user experience similar to those of native applications.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for processing mobile application pages, the method comprising:
receiving, by one or more processors of a computing device, an access request for a mobile application page;
requesting, by the one or more processors, the mobile application page from a server based on a uniform resource locator (URL) of the access request;
receiving, by the one or more processors, the mobile application page from the server, the mobile application page including a page layout and page components;
parsing, by the one or more processors, the mobile application page to convert the mobile application page to an object recognizable by a client terminal;
traversing, by the one or more processors, the page components of the object;
generating, by the one or more processors, an instance of each of the page components based on type of the one of the page components and a base component library of the client terminal;
configuring, by the one or more processors, the instance of the one of the page component based on one or more attributes of the one of the page components;
rendering, by the one or more processors, the instance of each of the page components;
returning, by the one or more processors, the rendered instance to the object to generate a local object corresponding to the mobile application page on the client terminal; and
displaying, by the one or more processors, the mobile application page based on the local object.

2. The method of claim 1, further comprising:
acquiring a component registry that is pre-stored on the client terminal prior to the generating the instance of each of the page components; and
initializing the base component library of the client terminal based on the component registry, wherein the component registry indicates a corresponding relationship between a type of a base component and a category of the base component, and wherein the base component includes at least one of a button component, an image component, a labeling component, and a text component.

3. The method of claim 1, further comprising:
acquiring category of one of the page component from the base component library of the client terminal based on type of the one of the page components prior to the generating the instance of the one of the page components; and
generating the instance of the one of the page components based on the category of the one of the page components.

4. The method of claim 1, wherein the one or more attributes of the page components comprise at least one of a style attribute, a component attribute, a logical attribute, an edit attribute, or a binding attribute, the component attribute comprises a character description of a component, the style attribute comprises a style description of the component including at least one of a width, a height, or a color, the logical attribute comprises control statements supported by the component including conditional statements or loop execute statements, the edit attribute comprises an editing rule of the component, the binding attribute comprises an event, animation, dynamic data, style, or bury point data that are bound to the component.

5. The method of claim 4, wherein the configuring the instance of the one of the page components based on the one or more attributes of the one of the page components comprises:
parsing the mobile application page to acquire at least one of the style attribute, the component attribute, the logical attribute, the edit attribute, or the binding attribute; and
configuring the instance of the one of the page components based on the at least one of the style attribute, the component attribute, the logical attribute, the edit attribute, or the binding attribute.

6. The method of claim 4, wherein a binding method of dynamic data of the binding attribute comprises at least one of dynamical binding, static binding, or dependent binding.

7. One or more computer-readable media storing executable instructions that, when executed by one or more processors, cause the one or more processors to perform acts comprising:
receiving a URL of a mobile application page from a client terminal;
acquiring a page identifier of the mobile application page based on the URL;
acquiring at least one of a custom page fragment of the mobile application page, a template, or page components of the mobile application page based on the page identifier;
generating the mobile application page based on the at least one of the custom page fragment of the mobile application page, the template, or the page components of the mobile application page;
including dynamic data and a style of a binding attribute of a page component in the mobile application page; and
returning the mobile application page to the client terminal, the mobile application page including a page layout and the page components.

8. The one or more computer-readable media of claim 7, wherein the URL comprises at least one of a name of the mobile application page, a namespace of the mobile application page, or a user account of the mobile application page.

9. The one or more computer-readable media of claim 8, wherein the acquiring the page identifier of the mobile application page based on the URL comprises:
acquiring at least one of the name of the mobile application page, the namespace of the mobile application page, or the user account of the mobile application page based on the URL; and
acquiring a page identifier of the mobile application page based on the at least one of the name of the mobile application page, the namespace of the mobile application page, or the user account of the mobile application page.

10. The one or more computer-readable media of claim 7, wherein the acquiring the page identifier of the mobile application page based on the URL comprises:
determining whether to use an evaluation template or an evaluation page to the mobile application page based on the page identifier of the mobile application page and a configuration file of a A/B test that is preset on a server terminal; and
in response to using the evaluation template or the evaluation page, designating a template identifier of the evaluation template or a page identifier of the evaluation page as the page identifier of the mobile application page.

11. The one or more computer-readable media of claim 7, wherein the one or more attributes of the one of the page components comprise at least one of a style attribute, a component attribute, a logical attribute, a edit attribute, or a binding attribute, the component attribute comprises a character description of a component, the style attribute comprises a style description of the component including a width, a height, or color, the logical attribute comprises control statements supported by the component including conditional statements or loop execute statements, the edit attribute comprises an editing rule of the component, and the binding attribute comprises at least one of an event, animation, dynamic data, style, or bury point data that are bound to the component.

12. The one or more computer-readable media of claim 7, the acts further comprising storing the at least one of the custom page fragment of the mobile application page, the template, or the page components of the mobile application page in a database.

13. The one or more computer-readable media of claim 7, the acts further comprising converting the mobile application page to a page expressed using a Json data exchange format or a XML markup extension language prior to the returning the mobile application page to the client terminal.

14. The one or more computer-readable media of claim 7, further comprising:
prior to the returning the mobile application page to the client terminal, determining whether the mobile application page includes a base component in a high version that is not supported by a base component library of the client terminal based on a version of the base component library of the client terminal; and
representing the base component in the high version using HTML5 in response to a determination that the mobile application page includes the base component in the high version that is not supported by the base component library of the client terminal.

15. The one or more computer-readable media of claim 7, the acts further comprising:
acquiring a client machine model of the client terminal and a version of a base component library of the client terminal prior to the returning the mobile application page to the client terminal;
determining whether a server terminal includes a configuration logic compatible to the version of a base component library of the client terminal based on a client machine model of the client terminal and a version of base component library of the client terminal; and
performing a compatibility process on a base component in a high version of the mobile application page based on the configuration logic to convert the base component to a base component recognizable by the client terminal in response to a determination that the server terminal includes a configuration logic compatible to the version of the base component library of the client terminal.

16. The one or more computer-readable media of claim 7, wherein the storing the mobile application page by the server terminal comprises:
receiving a page configuration instruction from the client terminal;
acquiring content of the mobile application page and at least one of a name of the mobile application page, a namespace of the mobile application page, or a user account of the mobile application page based on the page configuration instruction;
generating a page identifier of the mobile application page based on at least one of the name of the mobile application page, the namespace of the mobile application page, or the user account of the mobile application page; and
storing the page identifier and the content of the mobile application page.

17. A device for updating mobile application pages on a client terminal, the device comprising:
one or more processors; and
memory to maintain a plurality of components executable by the one or more processors, the plurality of components comprising:
a receiving request module configured to receive a URL of a mobile application page from a client terminal,
a first acquiring module configured to acquire a page identifier of the mobile application page based on the URL,
a second acquiring module configured to acquire at least one of a custom page fragment of the mobile application page, a template, or page components of the mobile application page based on the page identifier,
a generating module configured to generate the mobile application page based on at least one of the custom page fragment of the mobile application page, a template, or page components of the mobile application page,
a configuration module configured to include dynamic data and a style of a binding attribute of a page component in the mobile application page, and
a transmitting page module configured to receive the mobile application page from a server terminal, the mobile application page including a page layout and page components.

18. The device of claim 17, wherein the at least one of the custom page fragment of the mobile application page, the template, or the page components of the mobile application page is expressed using a Json data exchange format or a XML markup extension language.

19. The device of claim 17, wherein the plurality of components further comprise a configuration page module configured to configure the mobile application page, and wherein the configuration page module comprises:
a receiving instruction module configured to receive via the client terminal a page configuration instruction including at least one of content of the mobile application page, a name of the mobile application page, a namespace of the mobile application page, or a user account of the mobile application page, the content of the mobile application page including at least one of a custom page fragment of the mobile application page, a template, or page components of the mobile application page; and
a request storage module configured to transmit the page configuration instruction to the server terminal to request storing the mobile application page by the server terminal.

20. The device of claim 19, wherein the plurality of components further comprise:
an acquiring library module configured to acquire a page component library and a template library that are preset by the server terminal; and
an acquiring component template module configured to display the page components of the page component library and the template of the template library.
